(19) United States
(12) Patent Application Publication
(10) Pub. No.: US 2026/0243282 A1
(43) Pub. Date: Aug. 20, 2026

(54) WAVE AMPLIFIER FOR IMPACT DEVICES

(71) Applicant: Mississippi State University, Mississippi State, MS (US)

(72) Inventors: Marouane Jarachi, Starkville, MS (US); Luliang Zhang, Starksville, MS (US); Wilburn Whittington, Starkville, MS (US)

(73) Assignee: Mississippi State University, Mississippi State, MS (US)

(21) Appl. No.: 18/845,394

(22) PCT Filed: Mar. 13, 2024
(86) PCT No.: PCT/US2024/019668

§ 371 Date: Sep. 9, 2024

Related U.S. Application Data
(60) Provisional application No. 63/451,772, filed on Mar. 13, 2023.

(51) Int. Cl. F15B 21/12; B25D 17/00

(52) U.S. Cl. CPC F15B 21/12; B25D 17/005

(57) ABSTRACT

Systems and methods related to a pressure wave amplifier are disclosed. The pressure wave amplifier may be comprised of a geometry that allows pressure waves to be amplified. The geometry may decrease in cross-sectional area linearly or exponentially. Further, the pressure wave amplifier may be made of multiple decreasing cross-sections in series.

### CROSS REFERENCE TO RELATED APPLICATIONS

This application is a national stage application, filed under 35 U.S.C. § 371, of International Patent Application No. PCT/US2024/019668, filed on Mar. 13, 2024, which claims the benefit of and priority to U.S. Provisional Application No. 63/451,772, filed on Mar. 13, 2023, and entitled “Impact Pressure-Wave Amplifier Apparatus and Systems and Methods for the Use Thereof,” the disclosures of which are expressly incorporated by reference in their entirety.

### FIELD OF THE DISCLOSURE

This disclosure relates generally to a wave amplifier, and more particularly, to a pressure-wave amplifier with controllable high pressure and velocity for impact devices.

### BACKGROUND

Many fluid power machines are driven by high pressure sources that require components designed to handle the environments necessary for repetitive motions. In these machines, system components usually step-up pressures from lower pressure stages to higher pressure stages using hydraulic boosters, intensifiers, and other multi-stage devices. However, all of these systems suffer from a trade-off of flow velocity and pressure, as well as losses in the series and parallel network of components used in the power train.

Pressure waves are widely known to exist in quick changing hydraulic events, such as “water-hammer” and hydraulic impact. When fluid travels in a pipe network, as is typically done in fluid power machines, pressure waves are usually treated as one-dimensional and are treated akin to stress waves in solids. As such, the pressure wave propagation in changing cross-sectional area is widely known to depend on the change in impedance. However, one limitation in reduction of cross-sectional area suddenly is the pressure amplification. The maximum theorical amplification possible on a sudden cross-sectional change is 2 times the amplitude and is described by the following equation:

$$\frac{{σ}_{T}}{{σ}_{I}} = \frac{2 {A}_{1}}{{A}_{1} + {A}_{2}} with λ ≫ L \qquad ( 1 )$$

where A₁ and A₂ are the cross-section areas of the large bar and the small bar respectively, σ₁ and σ_{T} are the amplitude of the incident wave and the transmitted wave respectively, and λ and L are the wave and the transitional change lengths respectively. In other words, a sudden cross-sectional change will only result in amplification to a maximum of 2 times.

Accordingly, a device that can amplify pressure and velocity without losses and to a greater degree is of immense importance in the design of fluid power machines.

### SUMMARY

The problems expounded above, as well as others, are addressed by the following inventions, although it is to be understood that not every embodiment of the inventions described herein will address each of the problems described above.

In some embodiments, a wave amplifier is provided, the wave amplifier including an enclosed medium including a proximal end, a distal end, and an internal volume disposed between the proximal end and the distal end, the internal volume configured to contain a fluid or a solid material, a striker configured to impact the proximal end of the enclosed medium and generate a pressure wave, and wherein the internal volume has a cross-sectional area and the cross-sectional area decreases monotonically from the proximal end to the distal end, and the internal volume comprises a length greater than the pressure wave.

In one embodiment, the cross-sectional area of the internal volume decreases linearly from the proximal end to the distal end. In another embodiment, the cross-sectional area of the internal volume decreases exponentially from the proximal end to the distal end. In still another embodiment, the cross-sectional area of the internal volume decreases at least partially stepwise from the proximal end to the distal end. In yet another embodiment, the fluid is water. In another embodiment, the wave amplifier further includes one or more strain gauges operatively connected to the enclosed medium. In still another embodiment, solid material is aggregate, particulate, billet material, or combinations thereof.

In further embodiments, a wave amplifier is provided, the wave amplifier including an enclosed medium including a proximal end, a distal end, and an internal volume disposed between the proximal end and the distal end, the internal volume configured to contain a fluid or a solid material, a striker configured to impact the proximal end of the enclosed medium and generate a pressure wave having a first amplitude, wherein the internal volume has a cross-sectional area and the cross-sectional area decreases monotonically from the proximal end to the distal end, and the internal volume comprises a length greater than the pressure wave, and wherein, upon reaching the distal end of the enclosed medium, the pressure wave has a second amplitude greater than the first amplitude.

In one embodiment, the second amplitude is at least two times the first amplitude. In another embodiment, the cross-sectional area of the internal volume decreases linearly from the proximal end to the distal end. In still another embodiment, the cross-sectional area of the internal volume decreases exponentially from the proximal end to the distal end. In yet another embodiment, the cross-sectional area of the internal volume decreases at least partially stepwise from the proximal end to the distal end. In another embodiment, the fluid is water.

In still further embodiments, a system for amplifying a pressure wave is provided, the system including an enclosed medium including a proximal end, a distal end, and an internal volume disposed between the proximal end and the distal end, the internal volume configured to contain a fluid or a solid material, a striker configured to impact the proximal end of the enclosed medium and generate a pressure wave having a first amplitude, a launcher configured to cause the striker to impact the proximal end at an initial velocity, and wherein the internal volume has a cross-sectional area and the cross-sectional area decreases monotonically from the proximal end to the distal end, and the internal volume comprises a length greater than the first amplitude of the pressure wave.

In one embodiment, the launcher is a gas gun. In another embodiment, the cross-sectional area of the internal volume decreases linearly from the proximal end to the distal end. In still another embodiment, the cross-sectional area of the internal volume decreases exponentially from the proximal end to the distal end. In yet another embodiment, the cross-sectional area of the internal volume decreases at least partially stepwise from the proximal end to the distal end.

### BRIEF DESCRIPTION OF DRAWINGS

Further features and advantages can be ascertained from the following detailed description that is provided in connection with the drawings described below:

FIG. 1A is a sectional view of a wave amplifier according to one embodiment of the present disclosure.

FIG. 1B is a sectional view of a wave amplifier according to another embodiment of the present disclosure.

FIG. 2 is sectional view of the wave amplifier at different time increments t1, t2, and t3 upon impact with a striker according to one embodiment of the present disclosure.

FIG. 3A is a perspective view of a wave amplifier according to one embodiment of the present disclosure.

FIG. 3B is a perspective view of a wave amplifier according to another embodiment of the present disclosure.

FIG. 3C is a perspective view of a wave amplifier according to still another embodiment of the present disclosure.

FIG. 4A is graph of an example of a characteristic input wave from a striker in accordance with one embodiment of the present disclosure.

FIG. 4B is a graph of a Fourier decomposition of the characteristic input wave of FIG. 4A.

FIG. 5 is a graph of an example input pressure wave and output pressure wave.

FIG. 6 is a schematic diagram of a fluid-power system that utilizes a wave amplifier according to one embodiment of the present disclosure.

FIG. 7 is a schematic diagram of a solid extrusion system that utilizes a wave amplifier according to one embodiment of the present disclosure.

FIG. 8 shows a wave amplifier integrated with a demolition hammer and a fluid supply according to one embodiment of the present disclosure.

### DETAILED DESCRIPTION

Unless otherwise defined, all terms (including technical and scientific terms) in this disclosure have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly defined otherwise in this disclosure. For brevity or clarity, well known functions or constructions may not be described in detail.

The terms “about” and “approximately” shall generally mean an acceptable degree of error or variation for the quantity measured in light of the nature or precision of the measurements. Numerical quantities given in this description are approximate unless stated otherwise, meaning that the term “about” or “approximately” can be inferred when not expressly stated.

The terminology used throughout the disclosure is for the purpose of describing particular embodiments only and is not intended to be limiting. The singular forms “a,” “an,” and “the” are intended to include the plural forms as well, unless the context clearly indicates otherwise.

The terms “first,” “second,” “third,” and the like are used to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the disclosure. Likewise, terms like “top” and “bottom”; “front” and “back”; and “left” and “right” are used to distinguish certain features or elements from each other, but it is expressly contemplated that a top could be a bottom, and vice versa.

Spatially relative terms, such as “above,” “under,” “below,” “lower,” “over,” “upper,” and the like, may be used herein for ease of description to describe one element or feature's relationship to another when the apparatus is right side up as shown in the accompanying drawings.

The terms “coupled to,” “coupling,” “connected to,” “in connection with,” “in communication with,” or “connecting” include any suitable connection or communication, including mechanical connection, electrical connection (e.g., one or more wires), or signal-conducting channel (e.g., BLUETOOTH, near-field communication (NFC), or other inductive coupling or radiofrequency (RF) link).

The term “signal” means any suitable signal, for example, a voltage, a current, a duty cycle, a frequency of electrical oscillation, or a mechanical signal (e.g., pressure, vibration, a tap, or other mechanical signal) in some embodiments.

It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

The present disclosure relates to a wave amplifier for amplifying or attenuating waves moving through media. In some embodiments, the wave amplifier of the present disclosure amplifies a pressure wave to a desired amplitude by producing a downward force through a distally narrowing medium. By utilizing a geometry for the medium that decreases in cross-sectional area, the wave amplifier of the present disclosure can amplify pressure waves without the need for expensive high-pressure seals and pumps.

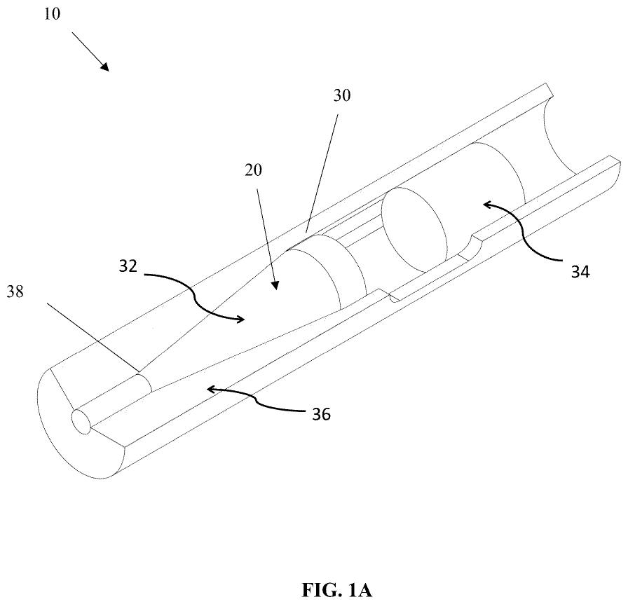

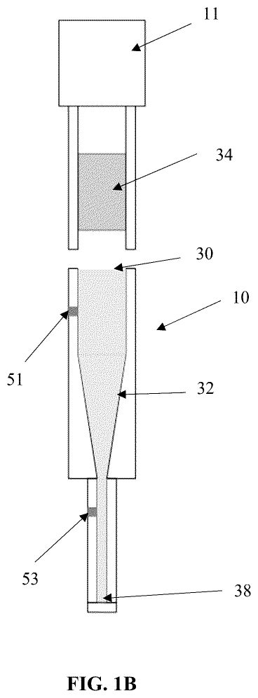

Referring to FIGS. 1A and 1B, a wave amplifier 10 according to one embodiment of the present disclosure is shown. The wave amplifier 10 includes an enclosed medium 32 having an internal volume 20. The enclosed medium 32 may be any suitable medium for housing a fluid. For example, the enclosed medium 32 may be a tube. In another embodiment, the enclosed medium 32 may be a pipe. In one embodiment, the internal volume 20 of the enclosed medium 32 is configured to hold a fluid. The fluid may include, but is not limited to, a gas or a liquid, such as water. In another embodiment, the internal volume 20 is configured to hold solid media, such as aggregate, particulate, billet material, or combinations thereof. In some embodiments, the enclosed medium 32 may be positioned within a hollow shell 36.

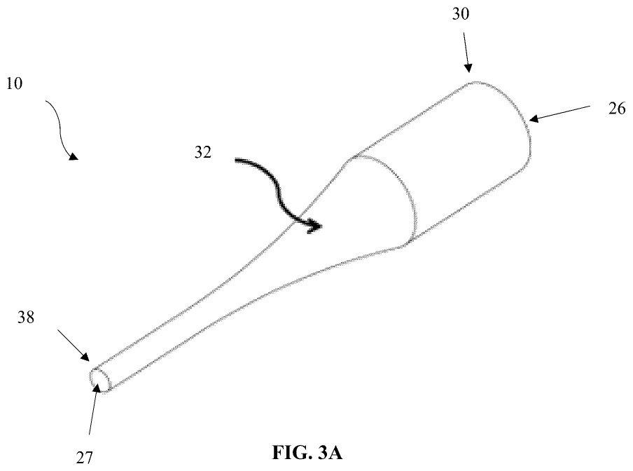

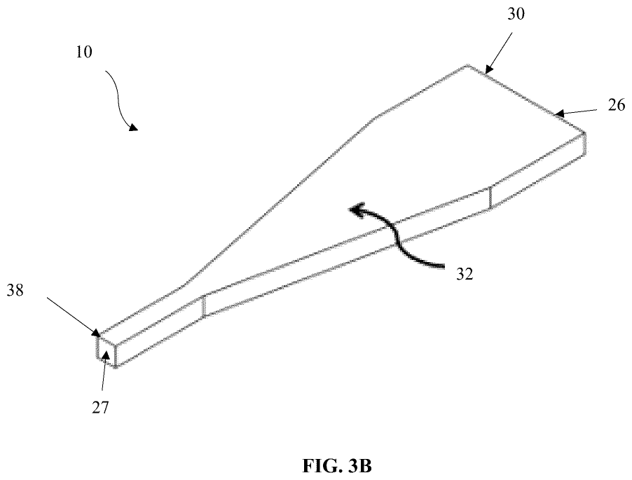

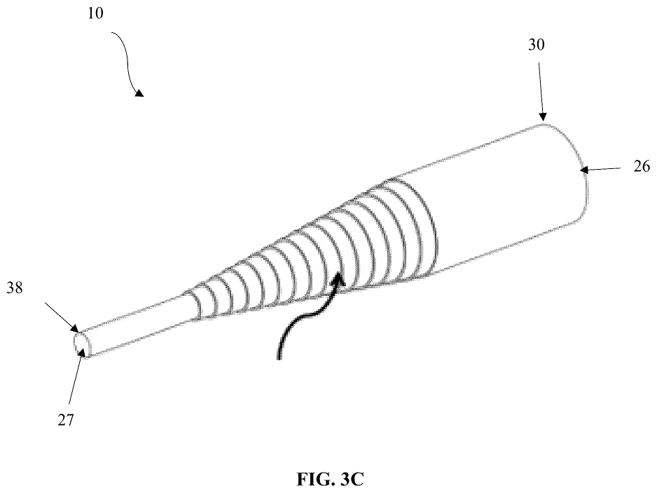

The enclosed medium 32 has a proximal end 30 and a distal end 38. As illustrated in FIG. 1, the cross section of the enclosed medium 32 is narrower at the distal end 38 than the cross section at the proximal end 30. In other words, the diameter of the enclosed medium 32 is greater at the proximal end 30 than at the distal end 38. In some embodiments, the cross-sectional area of the internal volume 20 decreases monotonically from the proximal end 30 to the distal end 38. As used herein, the term, “decreases monotonically,” refers to a cross-sectional area that is always decreasing (i.e., does not remain constant or increase). Without being bound by any particular theory, it is believed that the monotonically decreasing shape of the enclosed medium 32 is able to amplify or attenuate waves moving through the fluid or solid material housed therein to a greater degree than known amplification methods. As will be described with respect to FIGS. 3A-3C below, the cross-sectional area of the enclosed medium 32 can decrease linearly, exponentially, or be any continuous or noncontinuous decreasing function. In another embodiment, the cross-sectional area of the enclosed medium 32 can be made of multiple decreasing cross sections.

The proximal end 30 serves as an interface for the impact of a striker 34. The striker 34 may be any device that can generate short stress wavelength pulses. For example, the striker 34 may be a striker bar. In another embodiment, the striker 34 may be an anvil. As will be described in more detail below, a launcher 11 is configured to actuate the striker 34 and cause it to impact the enclosed medium 32 at the proximal end 30 and transfer a pressure wave to the enclosed medium 32. Upon impact, the pressure wave generated by the striker 13 traverses through the enclosed medium 32 starting at the proximal end 30 to the distal end 38 where it can be used by an impact device. As the pressure wave travels through the enclosed medium 32 from the proximal end 30 to the distal end 38, the wave amplifier 10 amplifies the pressure wave to a desired amplitude. In one embodiment, the length of the internal volume 20 from the proximal end 30 to the distal end 38 is greater than or equal to the pressure wave to be amplified, for instance, the pulse wavelength of the striker 34. As used herein, “pulse wavelength” refers to the distance between one pulse and the next as the pulse moves away from the striker through the media.

In some embodiments, the pressure wave may be recorded by a plurality of strain gauges. As shown in FIG. 1B, the wave amplifier 10 may include one or more incident strain gauges 51 and one or more transmission strain gauges 53. Strain gages measure the strains caused by the pressure waves. The incident strain gauge 51 may be installed on the wave amplifier 10 and be positioned near the proximal end 30. The transmission strain gauge 53 may be installed on the wave amplifier 10 and be positioned near the distal end 38.

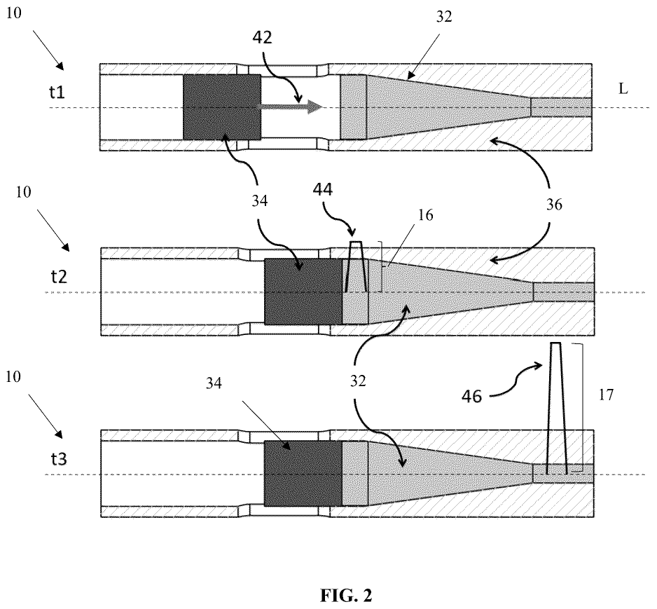

FIG. 2 shows the striker 34 and a cross-sectional view of the wave amplifier 10 at different time increments t1, t2, and t3 as the striker 34 moves along a longitudinal axis L. At the first time increment t1, the striker 34 is moving toward the enclosed medium 32 at an initial speed 42 along the longitudinal axis L. At the second time increment t2, a pressure-wave 44 having a first amplitude 16 is created by the impact of the striker 34 against the enclosed medium 32. The pressure-wave 44 is transferred and amplified until the third time increment t3, when the pressure-wave 44 has a second amplitude 17 greater than the first amplitude 16. The second amplitude 17 depicts the amplified pressure wave.

In some embodiments, the wave amplifier 10 amplifies pressure waves to a value depending on the ratio of diameters of the proximal end 30 and the distal end 38. In one embodiment, the wave amplifier 10 may amplify pressure waves such that the amplified pressure wave has an amplitude at least 1.5 times greater than the initial pressure wave. For example, the second amplitude 17 may be at least 1.5 times greater than the first amplitude 16. In another embodiment, the second amplitude 17 may be at least 1.75 times greater than the first amplitude 16. In still another embodiment, the second amplitude 17 may be at least 2 times greater than the first amplitude 16. In yet another embodiment, the second amplitude 17 may be at least 2.5 times greater than the first amplitude 16. In another embodiment, the second amplitude 17 may be at least 3 times greater than the first amplitude 16. In another embodiment, the second amplitude 17 may be at least 4 times greater than the first amplitude 16.

FIG. 3A shows the wave amplifier 10 according to another embodiment of the present disclosure. In this embodiment, the wave amplifier 10 includes the enclosed medium 32 having the proximal end 30 and the distal end 38. The proximal end 30 has a first cross-sectional area 26 and the distal end 38 has a second cross-sectional area 27. As shown in FIG. 3A, the first cross-sectional area 26 is greater than the second cross-sectional area 27 such that the cross-sectional area decreases from the proximal end 30 to the distal end 38. In this embodiment, as illustrated in FIG. 3A, the cross-sectional area decreases approximately exponentially from the proximal end 30 to the distal end 38.

FIG. 3B shows the wave amplifier 10 according to still another embodiment of the present disclosure. The wave amplifier 10 includes the enclosed medium 32 having the proximal end 30 and the distal end 38. The proximal end 30 has the first cross-sectional area 26 and the distal end 38 has the second cross-sectional area 27. As shown in FIG. 3B, the first cross-sectional area 26 is greater than the second cross-sectional area 27 such that the cross-sectional area decreases from the proximal end 30 to the distal end 38. In one embodiment, as illustrated in FIG. 3B, the cross-sectional area decreases approximately linearly from the proximal end 30 to the distal end 38.

FIG. 3C shows the wave amplifier 10 according to yet another embodiment of the present disclosure. The wave amplifier 10 includes the enclosed medium 32 having the proximal end 30 and the distal end 38. The proximal end 30 has the first cross-sectional area 26 and the distal end 38 has the second cross-sectional area 27. As shown in FIG. 3C, the first cross-sectional area 26 is greater than the second cross-sectional area 27 such that the cross-sectional area decreases from the proximal end 30 to the distal end 38. In one embodiment, as illustrated in FIG. 3C, the cross-sectional area decreases stepwise from the proximal end 30 to the distal end 38.

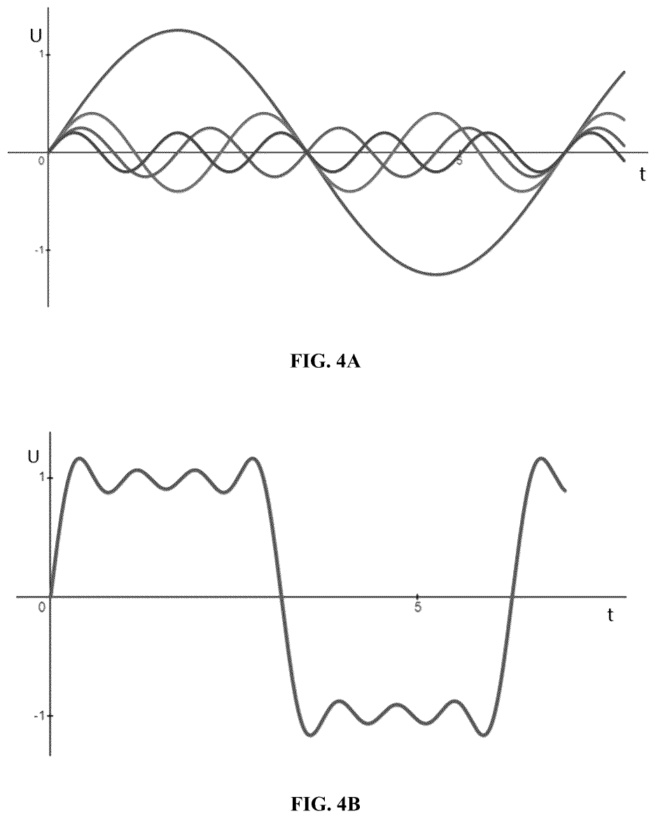

FIG. 4A is a graph of an example of an input pressure-wave from the striker 34 as it impacts the wave amplifier 10. The graph of FIG. 4A shows the horizontal axis in units of time and the vertical axis in units of pressure. As shown in FIG. 4A, input pressure-waves are made of a combination of different-frequency waves of which some high-frequency ones may be amplified and of which some low-frequency waves may or may not be amplified, depending on the geometry and configuration of the pressure-wave amplifier apparatus.

FIG. 4B is a graph of a Fourier decomposition of the input pressure-wave of FIG. 4A showing the resultant output wave. As will be appreciated by those skilled in the art, the Fourier decomposition is a tool for decomposing a given signal into its basic components. Using Fourier decomposition, the signal is broken down into different scales using a set of sine and cosine functions with different frequencies. As illustrated in FIGS. 4A and 4B, the pressure-wave is approximately a square wave. A square wave is a non-sinusoidal periodic waveform in which the amplitude alternates at a steady frequency between fixed minimum and maximum values, with the same duration at minimum and maximum.

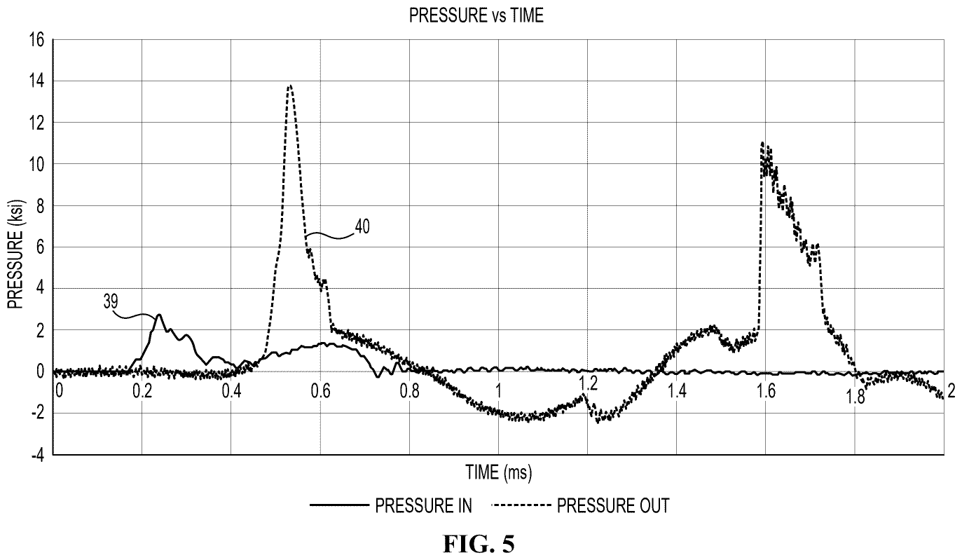

FIG. 5 is a graph of another example of an input pressure-wave from the striker 34 and an output pressure-wave. As shown in FIG. 5, the input pressure-wave 39 represents the pressure-wave as measured from the proximal end 30 of the wave amplifier 10 as the striker 34 impacts the wave amplifier 10. The output pressure wave 40 represents the pressure-wave as measured from the distal end 38. The horizontal axis is in units of time and the vertical axis is in units of pressure.

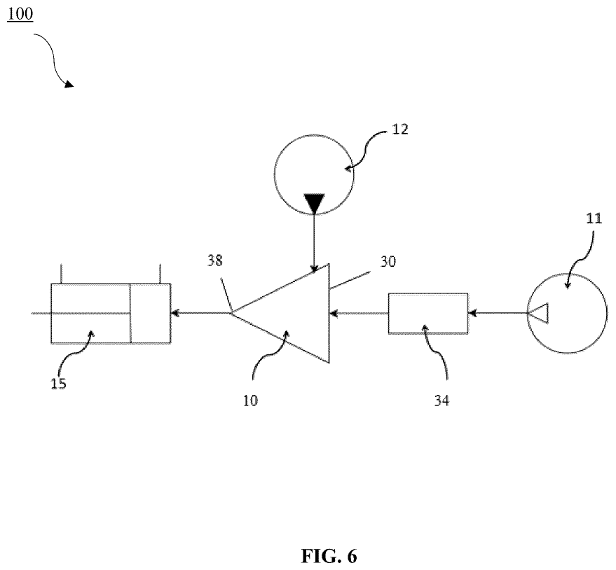

FIG. 6 is a schematic diagram of a fluid-power system 100 including the wave amplifier 10 according to one embodiment of the present disclosure. As illustrated in FIG. 6, the fluid-power system 100 includes a launcher 11 operatively connected to the striker 34. The launcher 11 may be any device that launches (or actuates) the striker 34 to create a pressure wave. For example, the launcher 11 may be a gas gun. In another embodiment, the launcher 11 may be an electrical, mechanical, pneumatic, hydraulic, thermal, magnetic, electromagnetic, or electro-pneumatic launcher or actuator, or a combination thereof. The striker 34 is operatively connected to the wave amplifier 10.

The fluid-power system 100 also includes a pump 12. The pump 12 is configured to add a fluid to the wave amplifier 10. In one embodiment, the fluid is added to the internal volume 20 of the enclosed medium 32. As described above, the fluid may be water, aggregate, particulate, or combinations thereof. In one embodiment, the pump 12 may continually feed the fluid to the wave amplifier 10. In another embodiment, the pump 12 may feed the fluid until the wave amplifier 10 contains a desired volume.

In operation, an initial velocity is given to the striker 34 by the launcher 11. Upon impact, the pressure wave generated by the striker 13 traverses through the wave amplifier 10 starting at the proximal end 30 of the wave amplifier 10 to the distal end 38 of the wave amplifier 10 where it can used by an impact device 15. In one embodiment, the impact device 15 may be any type of percussion tool having an electromotor or other motor drive and means for driving an impulse member. For instance, the percussion tool may be a jackhammer, paving breaker, chipping hammer, needle scaler, rivet buster, or a foundry tool. In another embodiment, the impact device 15 may be an accessory or piece of equipment for abrasive blasting machines or devices, such as devices or accessories for generating abrasive blasts, including blast guns (e.g., for generating high velocity abrasive fluid jets for cutting materials) and nozzles therefor. In another embodiment, the impact device 15 may be a spraying apparatus and nozzles therefor. In still another embodiment, the wave amplifier may be used with percussive tools, including.

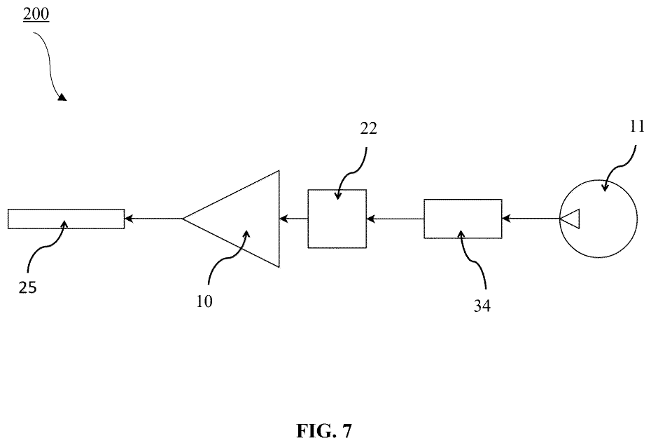

FIG. 7 is a schematic diagram of a solid extrusion system 200 including the wave amplifier 10 according to another embodiment of the present disclosure. Similar to the fluid power system 100, the solid extrusion system 200 includes the launcher 11 operatively connected to the striker 34. However, in this embodiment, when an initial velocity is given to the striker 34 by the launcher 11, the striker 34 impacts a billet 22. The billet 22 is then extruded through the wave amplifier 10 to a rod 25.

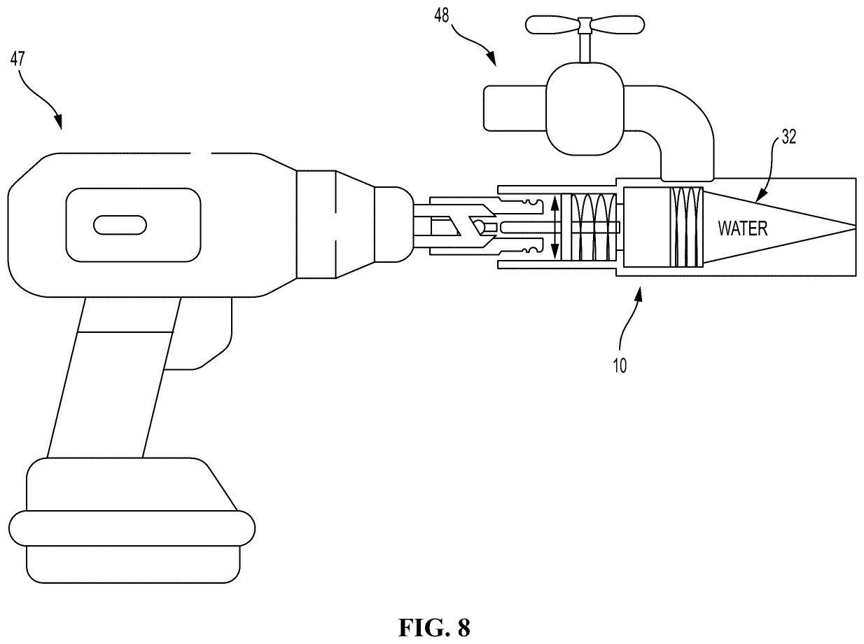

FIG. 8 is a schematic diagram of the wave amplifier 10 integrated with an impact device according to one embodiment of the present disclosure. As illustrated in FIG. 8, the wave amplifier 10 is operatively connected to a demolition hammer 47. A fluid supply 48 is fluidly coupled to the wave amplifier 10 and configured to supply the fluid to the enclosed medium 32 of the wave amplifier 10. In one embodiment, the fluid supply 48 may be a portable fluid supply, such as a water supply backpack. This allows for the impact device, such as the demolition hammer 47, integrated with the wave amplifier 10 to be portable battery powered device.

In still further embodiments, the wave amplifier 10 may be integrated into a load amplifying device for material testing. In this embodiment, the device may include the wave amplifier 10, the striker system described herein, and a split Hopkinson bar setup. In yet further embodiments, the wave amplifier 10 may be used in material extrusion of polymers and metals.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

While the foregoing specification has described specific embodiments of this invention and many details have been put forth for the purpose of illustration or example, it will be apparent to one skilled in the art that the invention is susceptible to additional embodiments and that certain of the details described herein can be varied considerably without departing from the basic principles of the invention. It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

What is claimed is:

1. A wave amplifier, comprising:
an enclosed medium comprising a proximal end, a distal end, and an internal volume disposed between the proximal end and the distal end, the internal volume configured to contain a fluid or a solid material,
a striker configured to impact the proximal end of the enclosed medium and generate a pressure wave, and
wherein the internal volume has a cross-sectional area and the cross-sectional area decreases monotonically from the proximal end to the distal end, and the internal volume comprises a length greater than the pressure wave.

2. The wave amplifier of claim 1, wherein the cross-sectional area of the internal volume decreases linearly from the proximal end to the distal end.

3. The wave amplifier of claim 1, wherein the cross-sectional area of the internal volume decreases exponentially from the proximal end to the distal end.

4. The wave amplifier of claim 1, wherein the cross-sectional area of the internal volume decreases at least partially stepwise from the proximal end to the distal end.

5. The wave amplifier of claim 1, wherein the fluid is water.

6. The wave amplifier of claim 1, further comprising one or more strain gauges operatively connected to the enclosed medium.

7. The wave amplifier of claim 1, wherein the solid material is aggregate, particulate, billet material, or combinations thereof.

8. A wave amplifier, comprising:
an enclosed medium comprising a proximal end, a distal end, and an internal volume disposed between the proximal end and the distal end, the internal volume configured to contain a fluid or a solid material,
a striker configured to impact the proximal end of the enclosed medium and generate a pressure wave having a first amplitude,
wherein the internal volume has a cross-sectional area and the cross-sectional area decreases monotonically from the proximal end to the distal end, and the internal volume comprises a length greater than the pressure wave, and
wherein, upon reaching the distal end of the enclosed medium, the pressure wave has a second amplitude greater than the first amplitude.

9. The wave amplifier of claim 8, wherein the second amplitude is at least two times the first amplitude.

10. The wave amplifier of claim 8, wherein the cross-sectional area of the internal volume decreases linearly from the proximal end to the distal end.

11. The wave amplifier of claim 8, wherein the cross-sectional area of the internal volume decreases exponentially from the proximal end to the distal end.

12. The wave amplifier of claim 8, wherein the cross-sectional area of the internal volume decreases at least partially stepwise from the proximal end to the distal end.

13. The wave amplifier of claim 8, wherein the fluid is water.

14. A system for amplifying a pressure wave, comprising:
an enclosed medium comprising a proximal end, a distal end, and an internal volume disposed between the proximal end and the distal end, the internal volume configured to contain a fluid or a solid material,
a striker configured to impact the proximal end of the enclosed medium and generate a pressure wave having a first amplitude,
a launcher configured to cause the striker to impact the proximal end at an initial velocity, and
wherein the internal volume has a cross-sectional area and the cross-sectional area decreases monotonically from the proximal end to the distal end, and the internal volume comprises a length greater than the first amplitude of the pressure wave.

15. The system of claim 14, wherein the launcher is a gas gun.

16. The system of claim 14, wherein the cross-sectional area of the internal volume decreases linearly from the proximal end to the distal end.

17. The system of claim 14, wherein the cross-sectional area of the internal volume decreases exponentially from the proximal end to the distal end.

18. The system of claim 14, wherein the cross-sectional area of the internal volume decreases at least partially stepwise from the proximal end to the distal end.
